(19) United States
(12) Patent Application Publication
(10) Pub. No.: US 2017/0357876 A1
(43) Pub. Date: Dec. 14, 2017

(54) METHOD AND SYSTEM FOR NOTIFYING USERS IN A SOCIAL MEDIA ENVIRONMENT BASED ON IDENTIFICATION AND COMPARISON OF DIGITAL IMAGES

(71) Applicant: Leigh Rothschild, Miami, FL (US)

(72) Inventor: Leigh Rothschild, Miami, FL (US)

(21) Appl. No.: 15/588,291

(22) Filed: May 5, 2017

Related U.S. Application Data
(60) Provisional application No. 62/347,620, filed on Jun. 9, 2016.

(51) Int. Cl. G06K 9/62; G06F 3/16; G06F 17/30

(52) U.S. Cl. CPC G06K 9/6212; G06F 17/3028; G06F 3/167; G06F 17/30247; G06K 2209/27

(57) ABSTRACT

A system, method, and device for identification and comparison of digital images in a social media environment are described. The method comprises of receiving, by a remote server, a first set of images from an electronic device associated with a first user. The remote server extracts one or more features of the received first set of images based on one or more image recognition algorithm. The remote server compares the extracted one or more features of the first set of images with one or more features of a second set of images. Each image of the second set of images is associated with a corresponding user. Based on the aforementioned comparison, the remote server further notifies the identity of one or more users associated with one or more images of the second set of images to the first user.

### FIELD OF THE DISCLOSURE

The present disclosure is generally related to notifying users in a social media environment and more particularly to notifying and connecting users in a social media environment based on identification and comparison of digital images.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In recent years, the social media platforms have burgeoned at a breakneck speed owing to the need of the people to get connected online. Such social media platforms provide a means for sharing information that pertains to personal, professional, and/or other aspects associated with the users. In most of the cases, the underlying basis of connection among the users of the social media platforms is common interests. The users use the searching feature provided by the social media platform for searching for other users that may have common interests. In certain other scenarios, the social media platforms offer suggestions to the users for connecting based on the interest areas of the users. However, the existing social media platforms do not provide a provision for identifying the users based on the digital media (such as images, videos, and/or the like) uploaded by the user on the servers associated with the social media platforms. Consequently, such social media platforms are not able to notify the users of the platform about the presence of users having similar interests.

In light of the aforementioned, a need exists for a social media platform that can facilitate the users of the platform to connect with each other based on identification and comparison of digital media uploaded by the users on the server of the social media platform.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a method and a system for notifying users in a social media environment based on identification and comparison of digital images is provided. The method comprises reception of a first set of images from an electronic device associated with a first user, by a remote server. The method further comprises identification of one or more features of the received first set of images based on one or more image recognition algorithms, by the remote server. The method further comprises comparison of the identified one or more features of the first set of images with the one or more features of a second set of images, by the remote server. Further, each image of the second set of images is associated with a corresponding user. The method further comprises notifying the identity of one or more users associated with one or more images of the second set of images to the first user based on the comparison, by the remote server.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments of various other aspects of the disclosure. The embodiments comprise notifying, a first user, an identity of the second user based on comparison of a first of images of the first user and the second set of images corresponding to a plurality of users, wherein the second user is one of the plurality of users. The embodiments further comprise notifying, a group of first users, an identity of one or more second users based on comparison of a first of images of the group of first users and the second set of images corresponding to plurality of users, wherein the one or more second users correspond to the plurality of users. Any person with ordinary skills in the art will appreciate that the illustrated element boundaries (e. g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a network environment for notifying users in a social media environment based on identification and comparison of digital images, according to an embodiment.

FIG. 2 illustrates a flowchart of a method for notifying users in a social media environment based on identification and comparison of digital images, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

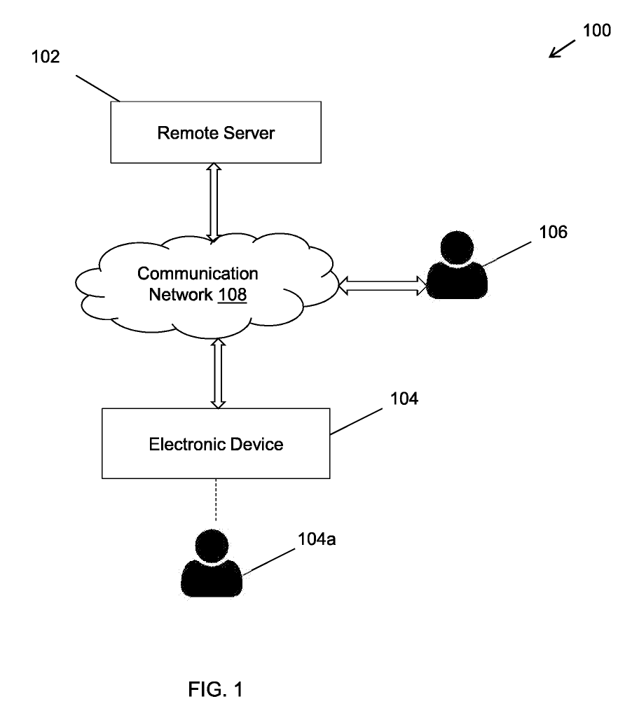

FIG. 1 illustrates a network environment for notifying users in a social media environment based on identification and comparison of digital images, according to an embodiment. The network environment 100 comprises a remote server 102 and an electronic device 104 associated with a first user 104a. The electronic device 104 may be communicatively connected with the remote server 102, via the communication network 108. The network environment may further comprise a second user 106 that may be communicatively connected with the remote server 102, via the communication network 108.

In an example embodiment, digital images may be received by a remote server 102 from the electronic device 104 associated with the first user 104a. The remote server 102 may comprise a video database, a content server, cloud storage, and/or any other storage means for storing the received digital images. Further, the remote server 102 may correspond to a server for providing online social media support to a plurality of users, such as the first user 104 and the second user 106. In an aspect, the digital images may be received form an electronic device 104, such as a smartphone, desktop computer, laptop computer, a video camera, tablet, or any other mobile device associated with the first user 104. Further, the remote server 102 may store the digital images corresponding to the second user 106 in an associated memory.

The communication network 108 may correspond to Internet, Wireless Fidelity (Wi-Fi) network, Wireless Local Area Network (WLAN), Local Area Network (LAN), satellite communications, Metropolitan Area Network (MAN), ZigBee, TCP/IP, and/or Ethernet. The remote server 102 and the electronic device 104 may be operable to connect to the communication network 108 in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, Infra Red (IR), IEEE 802.11, 802.16, cellular communication protocols, and/or Bluetooth (BT) communication protocols.

In an example embodiment, the remote server 102 may receive a first set of images from an electronic device 104 associated with the first user 104a. The received first set of images may correspond to a still images and/or video stream captured by the electronic device 104. In an example embodiment, the received first set of images may comprise metadata corresponding to the images and/or one or more user preferences specified by the first user 104a.

In an example embodiment, the metadata may comprise information of a location where the first set of images is captured by the electronic device 104. The metadata may further comprise a time of capture of the images. The metadata may further comprise identification information of a user (such as the user 104a) that captured the image and/or identification information of the electronic device 104 used for capturing the images. The metadata may further comprise one or more parameters associated with the electronic device 104 used for capturing the images. Such one or more parameters may include, but are not limited to, information on the weather conditions in which the images are captured, a camera setting such as zoom, aperture size, ASA/ISO settings, and the like, corresponding to the electronic device 104.

In an example embodiment, the one or more preferences specified by the first user 104a may correspond to the filters that may be indicative of interest areas of the first user 104a. For example, the interest areas may correspond to various fields of endeavour such as boats. Within the field of endeavours such boats, the one or more preferences may further include, but not limited to, specific interests such as size of the sailboats, colour of the preferred sailboats, manufacturer of the sailboats, and/or the like.

In an aspect, the remote server 102 may identify one or more features of the received first set of images based on one or more image recognition algorithms. Such one or more image recognition algorithms may be stored in the memory associated with the remote server 102. In an example embodiment, the one or more image recognition algorithms may be based on machine learning algorithms that may include, but are not limited to, classification algorithm, clustering algorithm, ensemble learning algorithm, multilinear subspace learning algorithm, real-valued sequence learning algorithm. The image recognition may be further based on open source image recognition applications such as TINA, Google Goggles™, and the like.

The remote server 102 may compare the identified one or more features of the first set of images with the one or more features of the second set of images. In an example embodiment, the second set of images may correspond to a plurality of users such that each of the second set of images is associated with a user. In an aspect, the comparison of the first set of images and the second set of images may be based on the identified one or more features of the first set of images and the second set of images. In an aspect, the identification of the one or more features of the second set of images may be based on the aforementioned image recognition. Further, the identified one or more features of the second set of images may be stored in the memory of the remote server 102.

In an example embodiment, the comparison of the first set of images and the second set of images is based on the identified one or more features, metadata, the one or more user preferences, and/or a combination thereof.

In an aspect, based on the result of the comparison of the images, the remote server 102 may determine an identity of the second user 106 from the plurality of users. The identity of the second user 106 may correspond to a user having digital images that have one or more features similar to the one or more features of first set of images of the first user 104a. In an example embodiment, the identity of the second user 106 may correspond to a user having digital images that have similar metadata and/or one or more user preferences as the first set of images of the first user 104a. In an example embodiment, the remote server 102 may determine an identity of one or more users, such as the second user 106, based on the aforementioned comparison. In such an embodiment, the remote server 102 may notify the presence determined identities of the one or more users, to the first user 104a. In an example embodiment, the remote server 104 may notify the identity of the second user 106 to the first user 104a, via the electronic device 104. In an aspect, the remote server 104 may further notify the identity of the first user 104a to the second user 106. A person of ordinary skill in the art will appreciate that the first user 104a may correspond to a group of first users. In an example embodiment, the notification corresponding to the identity of the second user 106 may be shared with one or more user that may be a part of the group of first users. Furthermore, in such an example embodiment, based on the comparison the group of first users may be notified the identity and/or the presence of the determined identities of the one or more users.

In an example embodiment, the notification of the identity and/or the presence of the second user 106 to the first user 104a (and/or vice versa) may be based on one or more communication service that includes, but is not limited to, an e-mail service, a Short Messaging Service (SMS), a Instant Messaging (IM) service. A person of ordinary skill in the art will appreciate that the aforementioned communication service may include any communication service that is currently known in the art or communication services that may be known in the future.

In an example embodiment, the remote server 102 may create an association between the first user 104a and the second user 106, based on comparison. In an example embodiment, the remote server 102 may create an association between the first user 104a and the second user 106 based on a user input received from the first user 104a corresponding to the notification. In an example embodiment, the aforementioned association between the users may be between one-to-one, one-to-many, many-to-one, or one-to-many in nature. For example, in an exemplary scenario, when the first user 104a corresponds to an advertiser, remote server 102 may notify the identity of a group of users that may correspond to a relevant audience for sharing the advertisements.

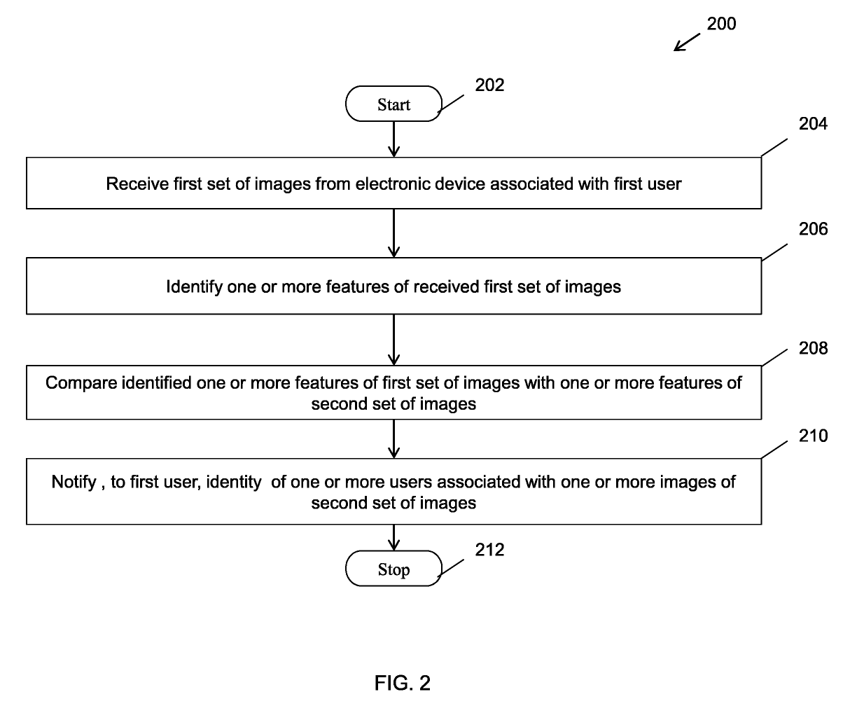

FIG. 2 illustrates a flowchart of a method for notifying users in a social media environment based on identification and comparison of digital images, according to an embodiment. FIG. 2 comprises a flowchart 200 that is explained in conjunction with the elements disclosed in FIG. 1.

The flowchart 200 of FIG. 2 shows the architecture, functionality, and operation for notifying users in a social media environment based on identification and comparison of digital images. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart starts at the step 202 and proceeds to step 204.

At step 204, a first set of images may be received by the remote server 102 from an electronic device associated with a first user 104a. In an exemplary scenario, the received first set of images may correspond to images of a sailboat. The received first set of images may further comprise metadata that includes, but is not limited to, location information associated with the first set of images, a time of capture of the first set of images, identification information of the first user 104a, identification information of the electronic device 104, one or more parameters associated with the electronic device 104 used for capturing the first set of images, and information on the weather conditions in which the first set of images is captured. The received first set of images may further comprise one or more preferences of the first user 104a that includes, but are not limited to, size of the sailboats, colour of the preferred sailboats, manufacturer of the sailboats.

At step 206, one or more features of the received first set of images may be identified by the remote server 102. The identification of the one or more features may be based on one or more image recognition algorithms. In the aforementioned exemplary scenario, one or more identified features may correspond to the one or more objects (such as sailboats) captured in the first set images. The remote server 102 may further identify the size, shape, colour, contrast, brightness, and/or other features corresponding to the first set of images or the one or more objects present in the first set of images.

At step 208, the identified one or more features of the first set of images may be compared with the one or more features of a second set of images, by the remote server 102. The one or more features of the second set of images may be identified by the remote server 102, in a method similar to identification of one or more features of the first set of images. Further, the identified one or more features of the second set of images may be stored an associated local memory of the remote server 102. In an exemplary scenario, the second set of images may correspond to a plurality of users communicatively coupled to the remote server 102. Such plurality of users may be a part of the social media network service provided by the remote server 102. In an example embodiment, the comparison of the first set of images and the second set of images is based on the identified one or more features, metadata, the one or more user preferences, and/or a combination thereof.

At step 210, based on the aforementioned comparison, a notification may be generated by the remote server 102 in order to notify the identity of the second user 106 to the first user 104a. Such a notification may be indicative of a similarity of the one or more compared features of the first set of images and the image associated with the second user 106. In another embodiment, the notification may be indicative of the similarity of the metadata and/or one or more preferences corresponding to the first set of images of the first user 104a and the second user 106. For example, the second user 106 may correspond to a user having an associated digital image of sailboat. In alternate scenario, the size, shape, colour, and/or manufacturer of the sailboat captured in the image associated with the second user 106 may correspond to the one or more preferences specified by the first user 104a. In another exemplary scenario, based on the comparison, the remote server 102 may determine one or more instances of second user 106 (or a group of users) that have images corresponding to one or more features, metadata, and/or one or more user preferences associated with the first set of images. In such a scenario, the remote server 102 may notify to the first user 104a, the identity of all the instances of the second user 106. In an example embodiment, the notification may be based on a communication service that includes, but is not limited to, an e-mail service, a Short Messaging Service (SMS), an Instant Messaging (IM) service. A person of ordinary skill in the art will appreciate that the aforementioned communication service may include any communication service that is currently known in the art or communication services that may be known in the future. The control passes to end step 212.

Various embodiments of the present disclosure include numerous advantages pertaining to the method and system for notifying users in a social media environment based on identification and comparison of digital images. Through various embodiments of the present disclosure it is evident that the users may use the image based identification and comparison to locate missing person, friends, relative, person or a group of person having similar interests in a field of work, and/or other persons of interest. Further, it is disclosed that the disclosed method and system is a more robust way of determining people sharing common interest over a social network as the system relies on numerous parameters that include the content of the digital images, the metadata, and/or the preferences specified by a user. Further, it is disclosed that due to the robustness the present method and system may be used by advertisers to identify the target audience and accordingly channelize advertisement campaigns to the relevant groups of users.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for notifying users in a social media environment based on identification and comparison of digital images, the method comprising:
receiving, by a remote server, a first set of images from an electronic device associated with a first user;
identifying, by the remote server, one or more features of the received first set of images based on one or more image recognition algorithms;
comparing, by the remote server, the identified one or more features of the first set of images with one or more features of a second set of images, wherein each image of the second set of images is associated with a corresponding user; and
notifying, by the remote server, identity of one or more users associated with one or more images of the second set of images to the first user based on the comparison.

2. The method of claim 1, wherein each of the received first set of images and the second set of images comprise metadata and/or one or more user preferences.

3. The method of claim 2, wherein the comparison of the first set of images and the second set of images is based on the identified one or more features, metadata, and/or the one or more user preferences.

4. The method of claim 2, wherein the metadata comprises one or more of: location information associated with an image, a time of capture of the image, identification information of a user that captured the image, identification information of the electronic device used for capturing the image, one or more parameters associated with the electronic device used for capturing the image, information on weather conditions in which the image is captured.

5. The method of claim 1, wherein the identity of the users associated with the second set of images is notified to a plurality of users.

6. The method of claim 1, wherein the notification of the identity of the users is based on one or more of: an e-mail service, a Short Messaging Service (SMS), an Instant Messaging (IM) service.

7. The method of claim 6, wherein the e-mail service is based on a voice based notification system.

8. The method of claim 1, wherein the received one or more images correspond to a video stream captured by the electronic device.

9. A system for notifying users in a social media environment based on identification and comparison of digital images, the system comprising:
one or more processors with an associated memory in a remote server configured to:
receive a first set of images from an electronic device associated with a first user;
identify one or more features of the received first set of images based on one or more image recognition algorithms stored in the memory;
compare at least the identified one or more features of the first set of images with one or more features of a second set of images stored in the memory, wherein each image of the second set of images is associated with a corresponding user; and
notify identity of one or more users associated with one or more images of the second set of images to the first user, based on the comparison.

10. The system of claim 9, wherein each of the received first set of images and the second set of images comprise metadata and/or one or more user preferences.

11. The system of claim 10, wherein the comparison of the first set of images and the second set of images is based on the identified one or more features, metadata, and/or the one or more user preferences.

12. The system of claim 10, wherein the metadata comprises one or more of: location information associated with an image, a time of capture of the image, identification information of a user that captured the image, identification information of the electronic device used for capturing the image, one or more parameters associated with the electronic device used for capturing the image, information on weather conditions in which the image is captured.

13. The system of claim 9, wherein the one or more processors are configured to notify identity of the users associated with the second set of images to a plurality of users.

14. The system of claim 9, wherein the notification of the identity of the users is based on one or more of: an e-mail service, a Short Messaging Service (SMS), an Instant Messaging (IM) service.

15. The system of claim 14, wherein the e-mail service is based on a voice based notification system.

16. The system of claim 9, wherein the received one or more images correspond to a video stream captured by the electronic device.
